(19) United States
(12) Patent Application Publication
(10) Pub. No.: US 2023/0345225 A1
(43) Pub. Date: Oct. 26, 2023

(54) METHOD FOR CORRECTING AN ACCESS AND MOBILITY MANAGEMENT FUNCTION (AMF) MODULE IN A WIRELESS COMMUNICATION SYSTEM

(71) Applicant: DISH Wireless L.L.C., Englewood, CO (US)

(72) Inventor: Xiaowen S. Robinson, Great Falls, VA (US)

(21) Appl. No.: 18/136,214

(22) Filed: Apr. 18, 2023

Related U.S. Application Data
(60) Provisional application No. 63/333,480, filed on Apr. 21, 2022.

(51) Int. Cl. H04W 8/08; H04W 48/18; H04W 60/00

(52) U.S. Cl. CPC H04W 8/08; H04W 48/18; H04W 60/00

(57) ABSTRACT

A method for correcting an access and mobility management function (AMF) module includes: receiving, from a user equipment (UE), a registration request message including a slice identifier, selecting, by a network node, an AMF module from a plurality of AMF modules each associated with one of a plurality of wireless communication service providers, the plurality of wireless communication service providers providing roaming services, determining, by the selected AMF module, whether the slice identifier matches a provisioned slice identifier associated with the UE, based on a determination that the slice identifier matches or does not match with the stored slice identifier, providing the roaming service by one of the plurality of wireless communication service providers associated with the selected AMF module or an AMF module associated with a corrected slice identifier.

### CROSS-REFERENCE TO RELATED APPLICATION

This application claims priority to U.S. Provisional Application Ser. No. 63/333,480, filed on Apr. 21, 2022, the entirety of which is hereby incorporated by reference.

### TECHNICAL FIELD

The present disclosure relates to a wireless communication system, and more particularly, a method of supporting different requirements of a plurality of wireless communication service providers using a slice-id.

### BACKGROUND

Network slicing allows multiple sub-networks (each with corresponding sets of network configuration parameters) to be defined on top of a common physical infrastructure. Each slice or portion of the network can be allocated corresponding network configuration parameters based on the specific needs of the application, use case, or customers. For example, an Access and Mobility Management Function (AMF) module, which is a control plane network functions (NF) of a 5G core network, can be allocated for services that would need ultra-low latency (URLLC) through the network slicing.

### SUMMARY

In some wireless communication systems an AMF module can be configured to communicate with various slices of a network underlying the wireless communication system. However, in wireless communication systems that support a plurality of wireless service providers to provide roaming services to a user equipment (UE), routing communications destined for radio access networks (RANs) of different wireless service providers can be challenging. This is because different wireless service providers can have different communication parameters and configurations that may be challenging to implement on a unified AMF module. For example, a first wireless service provider that does not provide Evolved Packet System Fallback (EPSFB) functionalities and a second wireless communication service provider that does provide the EPSFB functionality would have different requirements to provide roaming services. Configuring a unified AMF module to support such different requirements can be challenging and may require expensive processing, resources, bandwidth and/or additional software development.

The present disclosure is directed to wireless communication systems that support varying requirements of a plurality of wireless service providers by using a dedicated AMF module for each service provider based on a slice-id assigned to a UE. For example, communications from a particular UE is routed to a corresponding AMF module depending on which of the plurality of wireless service providers the UE is connected to. By providing such dedicated AMF modules to communicate with RAN resources of corresponding wireless service providers, multiple wireless service providers with varying requirements can be efficiently supported as roaming partners for the UE.

The present disclosure also describes technology directed to converging to a correct AMF module based on a subscriber service profile of a UE.

According to one aspect of the subject matter described in this application, a method for correcting an access and mobility management function (AMF) module can include receiving, from a user equipment (UE), a registration request message including a slice-id identifier, selecting, by a network node, an AMF module from a plurality of AMFs modules each associated with one of a plurality of wireless communication service providers, the plurality of wireless communication service providers providing roaming services, determining, by the selected AMF module, whether the slice-id identifier matches a provisioned slice-id identifier associated with the UE, based on a determination that the slice-id identifier matches with the provisioned slice-id identifier, providing the roaming service by one of the plurality of wireless communication service providers associated with the selected AMF module, and, based on a determination that the slice-id identifier does not match with the provisioned slice-id identifier, leveraging, by the selected AMF module, a reroute feature to the network node to correct the slice-id identifier, transmitting, to an AMF module associated with the corrected slice-id identifier, a message indicating the corrected slice-identifier, and providing the roaming service by one of the plurality of wireless communication service providers associated with the AMF module that is associated with the corrected slice-id identifier.

Implementations according to this aspect can include one or more of the following features. For example, the reroute feature can include transmitting, by the selected AMF module, a reroute request message to the network node, and rerouting, by the network node based on the reroute request message, the registration request message to an AMF module associated with the provisioned slice identifier.

In some examples, the slice identifier can be assigned to the UE. In some examples, the plurality of wireless communication service providers can be each assigned a corresponding slice identifier.

In some implementations, selecting the AMF module from the plurality of AMF modules can include, based on the UE supporting a slice differentiator included in the registration request message, selecting, by the network node, an AMF module corresponding to the slice identifier, and, based on the UE not supporting the slice differentiator, selecting, by the network node, a predefined AMF module from the plurality of AMF modules.

According to another aspect of the subject matter described in this application, a wireless communication system can include a network node that is configured to receive, from a user equipment (UE), a registration request message including a slice identifier, and a plurality of access and mobility management functions (AMF) modules each associated with one of a plurality of wireless communication service providers, the plurality of wireless communication service providers providing roaming services. The network node can be configured to select an AMF module from the plurality of AMF modules, the selected AMF module can be configured to determine whether the slice identifier matches a provisioned slice identifier associated with the UE, based on a determination that the slice identifier matches with the provisioned slice identifier, one of the plurality of wireless communication service providers associated with the selected AMF module can provide the roaming service, and, based on a determination that the slice identifier does not match with the provisioned slice identifier, the selected AMF module can be configured to leverage a reroute feature to the network node to correct the slice identifier, the network node can be configured to transmit, to an AMF module associated with the corrected slice identifier, a message indicating the corrected slice identifier, and one of the plurality of wireless communication service providers associated with the AMF module that is associated with the corrected slice identifier can be configured to provide the roaming service.

Implementations according to this aspect can include one or more of the following features. For example, the reroute feature can include transmitting, by the selected AMF module, a reroute request message to the network node, and rerouting, by the network node based on the reroute request message, the registration request message to an AMF module associated with the provisioned slice identifier.

In some examples, the slice identifier can be assigned to the UE. In some examples, the plurality of wireless communication service providers can be each assigned a corresponding slice identifier.

In some implementations, selecting the AMF module from the plurality of AMF modules can include, based on the UE supporting a slice differentiator included in the registration request message, selecting, by the network node, an AMF module corresponding to the slice identifier, and, based on the UE not supporting the slice differentiator, selecting, by the network node, a predefined AMF module from the plurality of AMF modules.

According to another aspect of the subject matter described in this application, a non-transitory recording medium storing a program, wherein execution of the program causes one or more computers of a wireless communication system to perform operations comprising receiving, from a user equipment (UE), a registration request message including a slice identifier, selecting, by a network node, an AMF module from a plurality of AMF modules each associated with one of a plurality of wireless communication service providers, the plurality of wireless communication service providers providing roaming services, determining, by the selected AMF module, whether the slice identifier matches a provisioned slice identifier associated with the UE, based on a determination that the slice identifier matches with the provisioned slice identifier, providing the roaming service by one of the plurality of wireless communication service providers associated with the selected AMF module, and, based on a determination that the slice identifier does not match with the provisioned slice identifier, leveraging, by the selected AMF module, a reroute feature to the network node to correct the slice identifier, transmitting, to an AMF module associated with the corrected slice identifier, a message indicating the corrected slice identifier, and providing the roaming service by one of the plurality of wireless communication service providers associated with the AMF module that is associated with the corrected slice identifier.

Implementations according to this aspect can include one or more of the following features. For example, the reroute feature can include transmitting, by the selected AMF module, a reroute request message to the network node, and rerouting, by the network node based on the reroute request message, the registration request message to an AMF module associated with the provisioned slice identifier.

In some examples, the slice identifier can be assigned to the UE. In some examples, the plurality of wireless communication service providers can be each assigned a corresponding slice identifier.

In some implementations, selecting the AMF module from the plurality of AMF modules can include, based on the UE supporting a slice differentiator included in the registration request message, selecting, by the network node, an AMF module corresponding to the slice identifier, and, based on the UE not supporting the slice differentiator, selecting, by the network node, a predefined AMF module from the plurality of AMF modules.

Further, if a slice-id is erroneous (e.g., the slice-id may be missing a slice differentiator (SD) part or misconfigured on a UE), the slice-id can be corrected based on a subscriber service profile of the UE.

### BRIEF DESCRIPTION OF THE DRAWINGS

FIG. 1 is a diagram illustrating an example of a wireless communication system.

FIG. 2 is a diagram illustrating an example of a wireless communication system with a slice-id assigned to each UE.

FIGS. 3-6 are diagrams illustrating example methods of correcting an AMF module based on a subscriber service profile of a UE.

FIG. 7 is a diagram illustrating an example of a computing environment.

FIG. 8 is a flowchart showing a registration procedure.

FIG. 9 is a flowchart showing a slice-id correction procedure.

### DETAILED DESCRIPTION

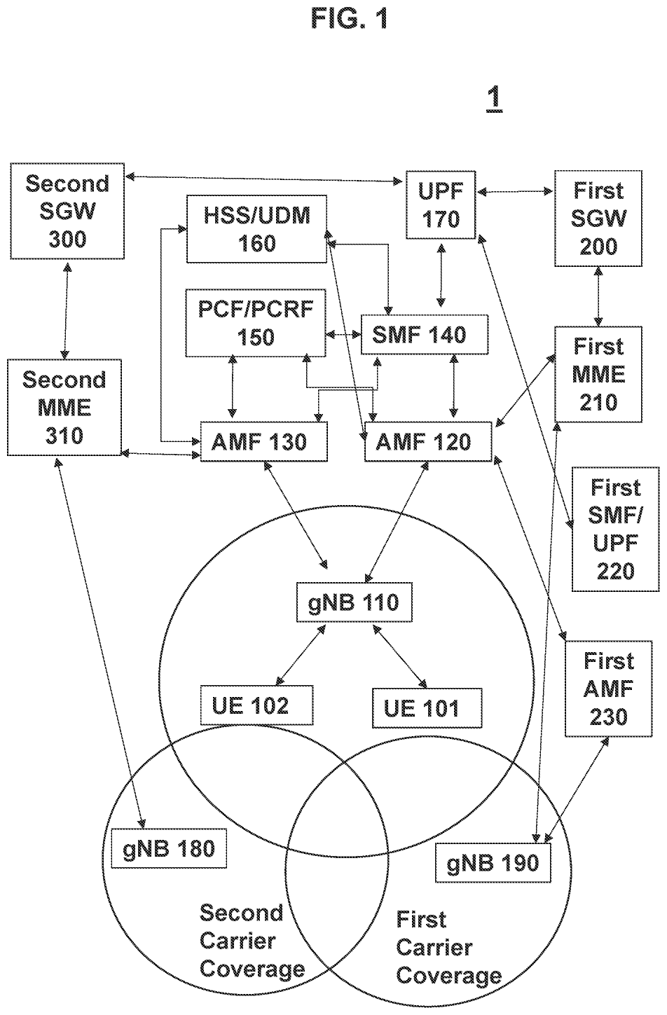

FIG. 1 is a diagram illustrating an example of a wireless communication system 1. Referring to FIG. 1, a wireless communication system 1 can include UEs 101 and 102, gNBs 110, 180, and 190 (e.g., a base station supporting 5G New Radio), AMF modules 120 and 130, a session management function (SMF) module 140, a policy control function/policy and charging rule function (PCF/PCRF) module 150, a home subscriber server/unified data -management (HSS/UDM) module 160, a user plane function (UPF) module 170, a first serving gateway (SGW) module 200, a first Mobility Management Entity (MME) module 210, a first SMF/UPF module 220, a first AMF module 230, a second SGW module 300, and a second MME module 310.

The UE 101 and 102 can include a terminal, Mobile Equipment (ME), or Mobile Station (MS). A UE can be a portable device such as a notebook computer, mobile phone, Personal Digital Assistant (PDA), smart phone, or a multimedia device, or a fixed device such as a Personal Computer (PC) or vehicle-mounted device. A UE can include a communication module configured to transmit and receive a signal, a processor configured to control the communication module, and a memory configured to store information.

Each of the gNBs 110, 180, and 190 can be a network node in charge of transmission/reception of wireless signals with the UE 101 and 102. In some implementations, each of the gNBs 110, 180, and 190 can be a RAN network node. The gNB can support functions for radio resource management (i.e., radio bearer control and radio admission control), connection mobility control, the dynamic allocation (i.e., scheduling) of resources to a UE in the uplink/downlink, Internet protocol (IP) header compression, the encryption and integrity protection of a user data stream, the selection of an AMF module upon attachment of a UE, user plane data routing to an UPF(s), control plane information routing to an AMF module, connection setup and release, the scheduling and transmission of a paging message (generated from an AMF module), the scheduling and transmission of system broadcast information, a measurement and measurement report configuration for mobility and scheduling, transport level packet marking in the uplink, session management, the support of network slicing, QoS flow management and mapping to a data radio bearer, the support of a UE that is an inactive mode, the distribution function of an NAS message, an NAS node selection function, radio access network sharing, and dual connectivity. In some implementations, gNB 110 pertains to both a first wireless communication provider and a second wireless communication provider, gNB 190 pertains to the first wireless communication provider, and gNB 180 pertains to the second wireless communication provider.

The AMF modules 120 and 130 can provide a function for access of a UE and mobility management. The AMF module can support functions, such as signaling between Core Network (CN) nodes for mobility between 3GPP access networks, the termination of a radio access network (RAN) control plane (CP) interface, the termination of NAS signaling, NAS signaling security (NAS ciphering and integrity protection), AS security control, registration area management, connection management, idle mode UE reachability (including control and execution of paging retransmission), mobility management control (subscription and policy), intra-system mobility and inter-system mobility support, the support of network slicing, SMF selection, lawful interception (for an AMF event and an interface to an LI system), the provision of transfer of a session management (SM) message between a UE and an SMF, a transparent proxy for SM message routing, access authentication, access authorization including a roaming right check, the provision of transfer of an SMS message between a UE and an Short Message Service function, a security anchor function (SEA) and/or security context management (SCM).

The SMF module 140 can provide a session management function. The SMF module 140 can support functions, such as session management, UE IP address allocation and management, the selection and control of the UP function, a traffic steering configuration for routing traffic from the UPF to a proper destination, the termination of an interface toward policy control functions, the execution of the control part of a policy and QoS, lawful interception, the termination of the SM part of an NAS message, downlink data notification, the initiator of AN-specific SM information, the determination of an SSC mode of a session, and a roaming function. The SMF module 140 can be responsible for interacting with the decoupled data plane, creating updating and removing Protocol Data Unit (PDU) sessions, and managing session context with the User Plane Function (UPF) module.

The PCF/PCRF module 150 can provide a function for receiving information about a packet flow from an application server and determining a policy, such as mobility management and session management. For example, the PCF/PCRF module 150 can provide policy control decision and flows based charging control functionalities by identifying and tracking the service data flow, analyzing the type and volume being used, and applying charging rules. By way of further example, the PCF/PCRF module 150 can provide policy rules for application and service data flow detection, gating, quality of Service (QoS), and flow based charging to the SMF module 140. The PCF/PCRF module 150 can support functions, such as the support of a unified policy framework for controlling a network behavior, the provision of a policy rule so that a CP function(s) (e.g., AMF or SMF) can execute a policy rule, and the implementation of a front end for accessing related subscription information in order to determine a policy within user data repository.

The HSS/UDM module 160 is a database (DB) that represents subscriber information and that stores the subscription data of a user, policy data, etc.

The UPF module 170 can support functions, such as an anchor point for intra/inter RAT mobility, the external PDU session point of interconnection to a data network, packet routing and forwarding, a user plane part for the execution of packet inspection and a policy rule, lawful interception, a traffic usage report, an uplink classifier for supporting the routing of traffic flow of a data network, a branching point for supporting a multi-home PDU session, QoS handling (e.g., the execution of packet filtering, gating and an uplink/downlink rate) for a user plane, uplink traffic verification, transport level packet marking within the uplink and downlink, downlink packet buffering, and a downlink data notification triggering function. Some or all of the functions of the UPF module may be supported within a single instance of one UPF module. The UPF module 170 can do all of the work to connect the actual data coming over the Radio Area Network (RAN) to the Internet and other application networks.

The First and Second SGW modules 200 and 300 are responsible for routing, forwarding, packet marking and buffering, user mobility management, and support for handover connections between two gNBs.

The first and second MME modules 210 and 310 are capable of performing various functions such as NAS signaling security, AS (Access Stratum) security control, inter-CN (Core Network) signaling for supporting mobility among 3GPP access networks, IDLE mode UE reachability (including performing and controlling retransmission of a paging message), TAI (Tracking Area Identity) management (for IDLE and active mode UEs), PDN GW and SGW selection, MME selection for handover in which MMEs are changed, SGSN selection for handover to a 2G or 3G 3GPP access network, roaming, authentication, bearer management function, and support for transmission of a PWS (Public Warning System) (including Earthquake and Tsunami Warning System (ETWS) and Commercial Mobile Alert System (CMAS)) message.

In some implementations, a first wireless communication service provider, which is not configured to provide EPSFB, can be associated with the AMF module 120, the first SGW module 200, the first MME module 210, the first SMF/UPF module 220, and the first AMF module 230. The first MME module 210 and the first—AMF module—230 can perform features (e.g. inter-system mobility) described above with respect to the AMF modules 120 and 130—, the SMF module 140, and the UPF module 170.

A second wireless communication service provider, which is configured to provide EPSFB, can be associated with the AMF module 130, the second SGW module 300, and the second MME module 310.

As depicted in FIG. 1, the AMF module 120 is dedicated to the first wireless communication service provider and the AMF module 130 is dedicated to the second wireless communication based on a slice-id. For example, if the UE 101 assigned with slice-id 1 is located within an area where both of the first wireless communication service provider and the second wireless communication service provider can provide roaming services, the gNB 110 can select the AMF module 120 based on the slice-id 1. By way of further example, if the UE 102 assigned with slice-id 2 is located within the area where both of the first wireless communication service provider and the second wireless communication service provider can provide roaming services, the gNB 110 can select the AMF module 130 based on the slice-id 2. Thus, the dedicated AMF module is configured for the specific wireless communication provider providing roaming services. Further, the slice-id can logically separate the first wireless communication service provider from the second wireless communication service provider. Such slice-id assignments are provided for the wireless communication system 1 to support a plurality of wireless communication providers to provide roaming services to the UE 101 and the UE 102 by routing communications destined for radio access networks (RANs) of different wireless communication providers. For example, the wireless communication system 1 can support varying requirements of a plurality of wireless communication providers by using a dedicated AMF module for each wireless communication provider based on a slice-id assigned to a UE.

If a UE is within an area where only the first wireless communication provider can provide roaming services, the gNB 190 can select the first AMF module 230 for the UE, and, if a UE is within an area where only the second wireless communication provider can provide roaming services, the gNB 180 can connect to the second MME module 310.

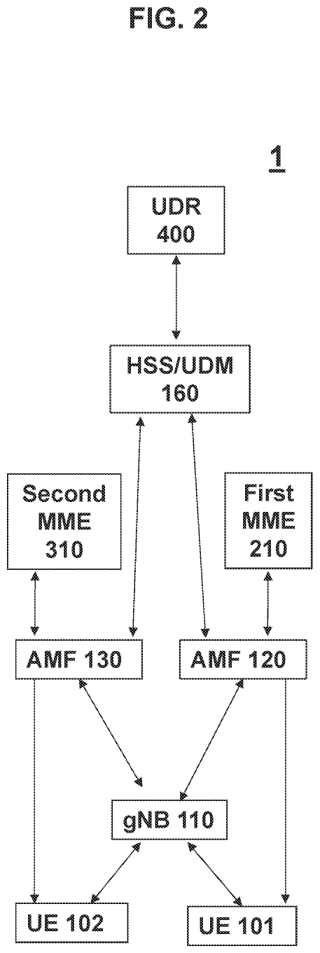

FIG. 2 is a diagram illustrating an example of a wireless communication system 1 with a slice-id assigned to each UE 101 and 102.

Referring to FIG. 2, the UE 101 can be configured with slice-id 1 and the UE 102 can be configured with slice-id 2. For example, each UE subscribing to a service in which the first wireless communication service provider and the second wireless communication service provider provide roaming services can be provisioned with a default slice-id.

The gNB 110 can be configured to, based on the provisioned slice-id, select the AMF module 120 or the AMF module 130. For example, if UE 101 is provisioned with slice-id 1, the gNB 110 can select the AMF module 120.

Upon the selection, the AMF module 120 can allow the UE 101 to roaming in the first wireless communication service provider. In some implementations, the AMF module 120 can send a registration accept message to the UE 101 including a message indicating that (i) interworking without a connection between the first MME module 210 and the AMF module 120 is not supported, (ii) an emergency bearer service is supported, and (iii) IP Multimedia Subsystem (IMS) voice over PS session is supported. Moreover, the AMF module 120 can send an initial context setup request message to the gNB 110 indicating redirection for voice EPS fallback is not supported.

The AMF module 120 can further configure an equivalent PLMN list to support mobility between a home network and a roaming network, which allows a network to provide the UE 101 with a list of PLMN identities, and configure that an EPSFB is not supported.

By way of further example, if the UE 102 is provisioned with slice-id 2, the gNB 110 can select the AMF module 130.

Upon the selection, the AMF module 130 can allow the UE 102 to roaming in the second wireless communication service provider. In some implementations, the AMF module 130 can send a registration accept message to the UE 102 including a message indicating that (i) interworking without a connection between the second MME module 310 and the AMF module 130 is not supported, (ii) emergency bearer service is supported, and (iii) IMS voice over PS session is supported. Moreover, the AMF module 130 can send an initial context setup request message to the gNB 110 indicating redirection for voice EPS fallback is supported.

The AMF module 130 can further configure an equivalent PLMN list to support mobility between a home network and a roaming network, which allows a network to provide the UE 102 with a list of PLMN identities, and configure that an EPSFB is supported.

As depicted in FIG. 2, the wireless communication system 1 can further include a User Data Repository (UDR) module 400 connected to the HSS/UDM module 160. The UDR module 400 can store data required for functions provided by the HSS/UDM module 160 and a policy profile required by the PCF/PCRF module 150. The UDR module 400 can store information that (i) the UE 101 is roaming in the first wireless communication service provider, (ii) the UE 102 is roaming in the second wireless communication service provider, and (iii) network slice selection assistance information (NSSAI) is slice-id 1 for UE 101 and slice-id 2 for UE 102, and send the information to the AMF modules 120 and 130.

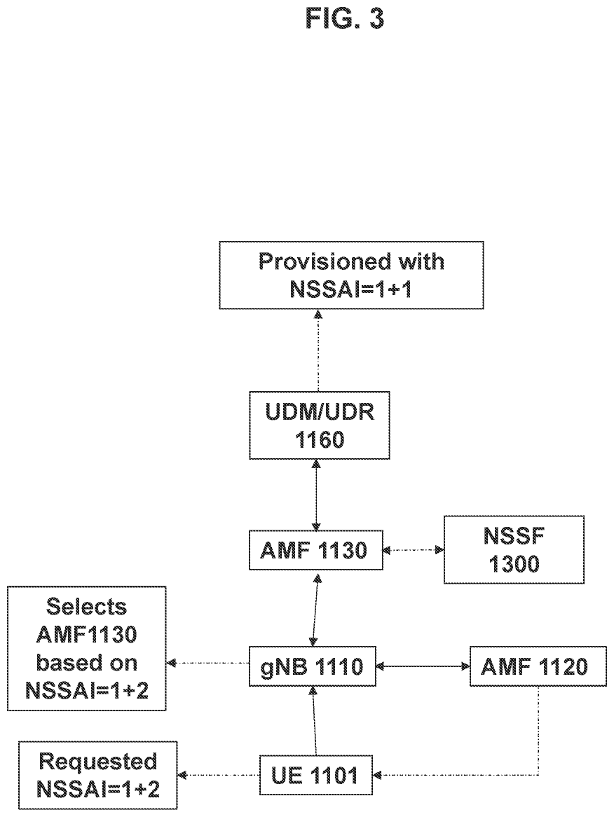

FIGS. 3-6 are diagrams illustrating a method of correcting an AMF module based on a subscriber service profile of a UE, if a slice-id is erroneous (e.g., the slice-id may be missing a slice differentiator (SD) part or misconfigured on a UE). In some implementations, the UE is allowed to roam to either a first wireless communication service provider or a second wireless communication service provider, but not both. The wireless communication system 1 can route to a corrected AMF module based on a subscriber service profile associated with a UE. The wireless communication system 1 can leverage NAS reroute feature in the AMF module to direct gNB to the correct AMF module. For example, the NAS reroute feature can enable the AMF module to reroute the Initial UE Message to another AMF module. The AMF module can initiate the procedure by sending a REROUTE NAS REQUEST message to the gNB that reroutes the Initial UE Message to an AMF module indicated by the AMF Set ID IE. The AMF Set ID IE may refer to a provisioned slice-id that can be retrieved by the UDM/UDR module.

FIG. 3 depicts a case where a UE 1101 is assigned with a wrong slice-id (NSSAI=1+2). In some implementations, NSSAI can include (i) slice/service type (SST) indicating the operation of a network slice expected from a viewpoint of a function and service and (ii) slice differentiator (SD) that is optional information supplementing an SST(s). For example, the UE 1101 requests NSSAI=1+2, and, based on the requested NSSAI=1+2, the gNB 1110 can select AMF module 1130 corresponding to NSSAI=1+2. The AMF module 1130 can transmit a message to the UDM/UDR module 1160 to determine whether the requested NSSAI=1+2 is correct and the UDM/UDR module 1160 can return that the UE 1101 is provisioned with NSSAI=1+1 according to the data stored in the UDM/UDR module 1160. In response to the message from the UDM/UDR module 1160, the AMF module 1130 can leverage a NAS reroute feature to the gNB 1110 to correct that the slice-id should be NSSAI=1+1. In some implementations, the AMF module 1130 can leverage the NAS reroute feature to connect to an appropriate AMF with the corrected slice identifier. The gNB 1110 can send an initial UE message indicating that the slice-id should be NSSAI=1+1 to the AMF module 1120, and the AMF module 1120 can allow the UE 1101 to roam in a wireless communication service associated with the correct slice-id of NSSAI=1+1.

A Network Slicing Selection Function (NSSF) module 1300 can select the optimal network slice available for the service requested by the UE 1101 when various services are provided. In some implementations, the NSSF can be used to allocate an appropriate AMF if the current AMF is not able to support the network slice instances for a given device. For example, the NSSF module 1300 can provide the appropriate AMF information that supports the slice-id of NSSAI=1+1 according to the data stored in the UDM/UDR module 1160.

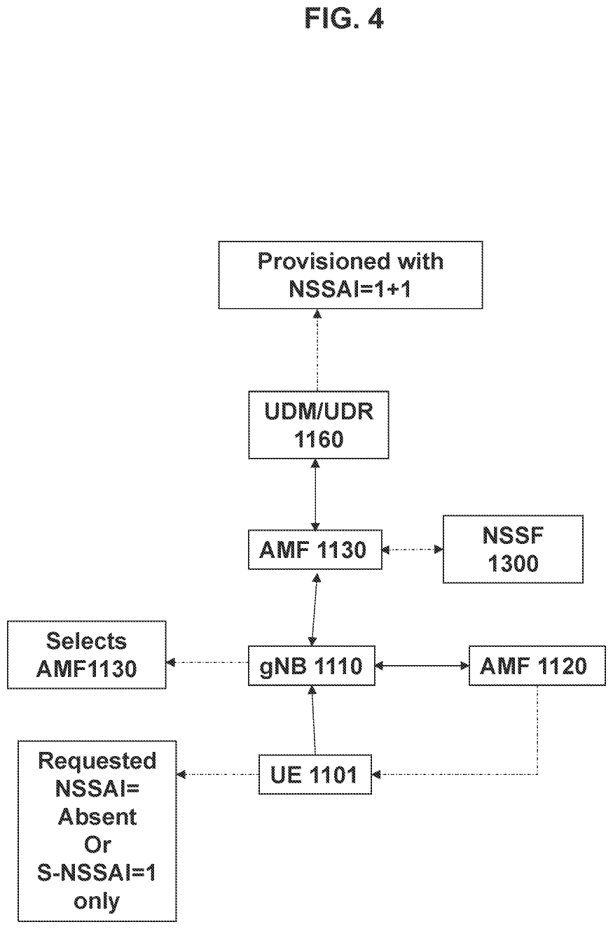

FIG. 4 depicts a case where a UE 1101 does not support a SD. For example, the UE 1101 may request to the gNB 1110 with NSSAI being absent or Single network slice selection assistance information (s-NSSAI) being 1 only. Based on the requested NSSAI being absent or s-NSSAI being 1 only, gNB 1110 can select default AMF module 1130. The AMF module 1130 can transmit a message to the UDM/UDR module 1160 to determine whether the requested slice-id is correct and the UDM/UDR module 1160 can return that the UE 1101 is provisioned with NSSAI=1+1 according to the data stored in the UDM/UDR module 1160. In response to the message from the UDM/UDR module 1160, the AMF module 1130 can leverage a NAS reroute feature to the gNB 1110 to the appropriate AMF and correct that the slice-id should be NSSAI=1+1. The gNB 1110 can send an initial UE message indicating that the slice-id should be NSSAI=1+1 to the AMF module 1120, and the AMF module 1120 can allow the UE 1101 to roam in a wireless communication service associated with the correct slice-id of NSSAI=1+1.

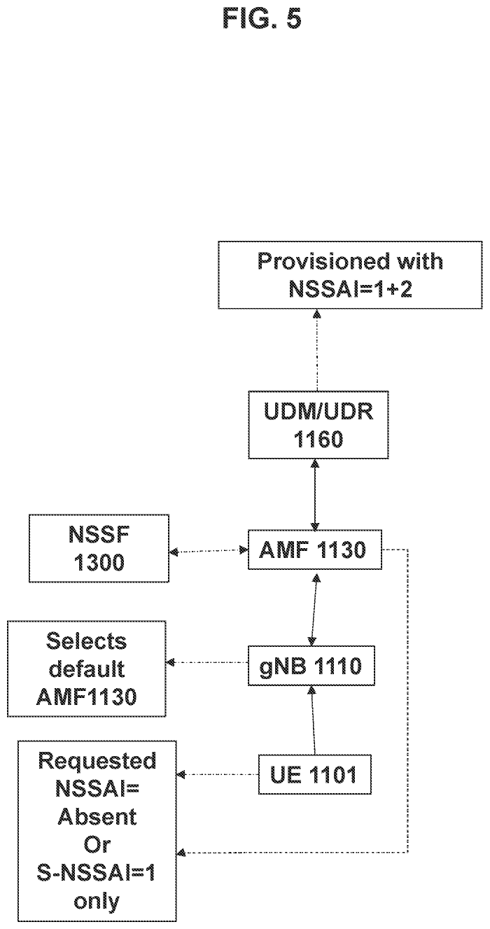

FIG. 5 depicts another case where a UE 1101 does not support a SD. For example, the UE 1101 may request to the gNB 1110 with NSSAI being absent or s-NSSAI being 1 only. Based on the requested NSSAI being absent or s-NSSAI being 1 only, the gNB 1110 can select default AMF module 1130. The AMF module 1130 can transmit a message to the UDM/UDR module 1160 to determine whether the requested slice-id is correct and the UDM/UDR module 1160 can return that the UE 1101 is provisioned with NSSAI=1+2 according to the data stored in the UDM/UDR module 1160. In response to the message from the UDM/UDR module 1160, the AMF module 1130 can allow the UE 1101 to roam in a wireless communication service associated with the correct slice-id of NSSAI=1+2.

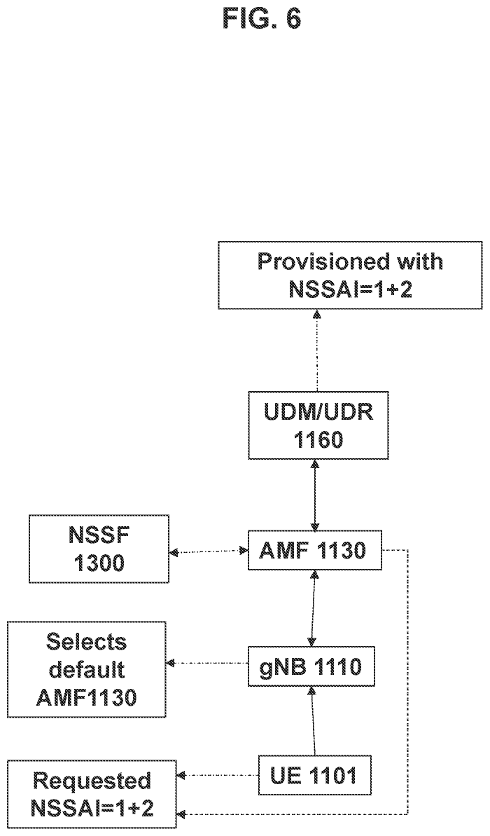

FIG. 6 depicts a case where a UE 1101 has a proper slice-id. For example, the UE 1101 may request to gNB 1110 with NSSAI=1+2. Based on the requested NSSAI=1+2, gNB 1110 selects the AMF module 1130. The AMF module 1130 can transmit a message to the UDM/UDR module 1160 to determine whether the requested slice-id is correct and the UDM/UDR module 1160 can return that the UE 1101 is provisioned with NSSAI=1+2 according to the data stored in the UDM/UDR module 1160. In response to the message from the UDM/UDR module 1160, the AMF module 1130 can allow the UE 1101 to roam in a wireless communication service associated with the correct slice-id of NSSAI=1+2.

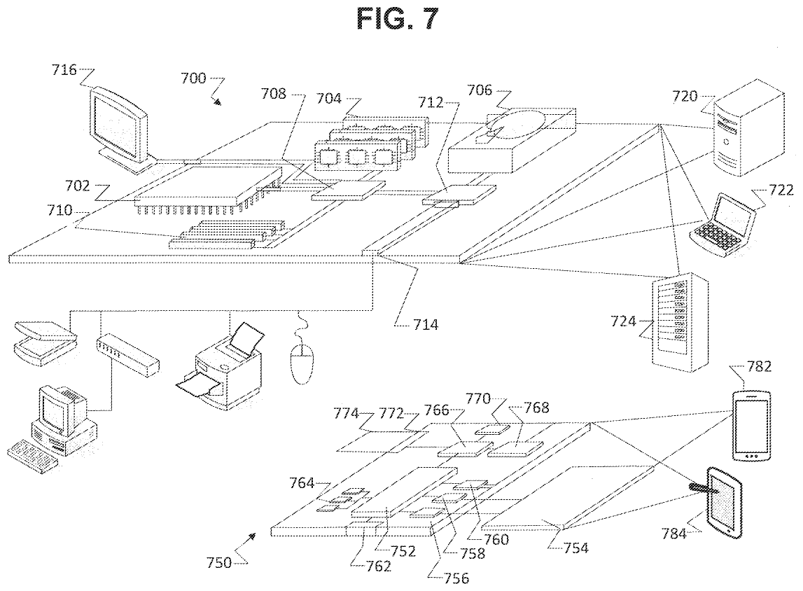

FIG. 7 shows an example of a computing device 700 and a mobile computing device 750 (also referred to herein as a user equipment) that are employed to execute implementations of the present disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 700 and/or the mobile computing device 750 can form at least a portion of the application installation environment described above.

The computing device 700 includes a processor 702, a memory 704, a storage device 706, a high-speed interface 708, and a low-speed interface 712. In some implementations, the high-speed interface 708 connects to the memory 704 and multiple high-speed expansion ports 710. In some implementations, the low-speed interface 712 connects to a low-speed expansion port 714 and the storage device 704. Each of the processor 702, the memory 704, the storage device 706, the high-speed interface 708, the high-speed expansion ports 710, and the low-speed interface 712, are interconnected using various buses, and may be mounted on a common motherboard or in other manners as appropriate. The processor 702 can process instructions for execution within the computing device 700, including instructions stored in the memory 704 and/or on the storage device 706 to display graphical information for a graphical user interface (GUI) on an external input/output device, such as a display 716 coupled to the high-speed interface 708. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of a computer-readable medium, such as a magnetic or optical disk.

The storage device 706 is capable of providing mass storage for the computing device 700. In some implementations, the storage device 706 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 702, perform one or more methods, such as those described above. The instructions can also be stored by one or more storage devices, such as computer-readable or machine-readable mediums, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards. In the implementation, the low-speed interface 712 is coupled to the storage device 706 and the low-speed expansion port 714. The low-speed expansion port 714, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 714 through a network adapter. Such network input/output devices may include, for example, a switch or router.

The computing device 700 may be implemented in a number of different forms, as shown in the FIG. 7. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device, such as a mobile computing device 750. Each of such devices may contain one or more of the computing device 700 and the mobile computing device 750, and an entire system may be made up of multiple computing devices communicating with each other. In some implementations, the computing device 700 can be implemented to perform network functionalities in cloud environments.

The mobile computing device 750 includes a processor 752; a memory 764; an input/output device, such as a display 754; a communication interface 766; and a transceiver 768; among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate. In some implementations, the mobile computing device 750 may include a camera device(s).

The processor 752 can execute instructions within the mobile computing device 750, including instructions stored in the memory 764. The processor 752 may be implemented as a chipset of chips that include separate and multiple analog and digital processors. For example, the processor 752 may be a Complex Instruction Set Computers (CISC) processor, a Reduced Instruction Set Computer (RISC) processor, or a Minimal Instruction Set Computer (MISC) processor. The processor 752 may provide, for example, for coordination of the other components of the mobile computing device 750, such as control of user interfaces (UIs), applications run by the mobile computing device 750, and/or wireless communication by the mobile computing device 750.

The processor 752 may communicate with a user through a control interface 758 and a display interface 756 coupled to the display 754. The display 754 may be, for example, a Thin-Film-Transistor Liquid Crystal Display (TFT) display, an Organic Light Emitting Diode (OLED) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a Single in Line Memory Module (SIMM) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provided as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 752, perform one or more methods, such as those described above. The instructions can also be stored by one or more storage devices, such as one or more computer-readable or machine-readable mediums, such as the memory 764, the expansion memory 774, or memory on the processor 752. In some implementations, the instructions can be received in a propagated signal, such as, over the transceiver 768 or the external interface 762.

The mobile computing device 750 may communicate wirelessly through the communication interface 766, which may include digital signal processing circuitry where necessary. The communication interface 666 may provide for communications under various modes or protocols, such as long-term evolution (LTE), 5G New Radio (NR), Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS), etc. Such communication may occur, for example, through the transceiver 768 using a radio frequency. In addition, short-range communication, such as using a Bluetooth or Wi-Fi, may occur. In addition, a Global Positioning System (GPS) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in FIG. 7. For example, it may be implemented in the UE described with respect to FIGS. 1-6. Other implementations may include a phone device 782 and a tablet device 784. The mobile computing device 750 may also be implemented as a component of a smart-phone, personal digital assistant, AR device, or other similar mobile device.

The computing device 700 may be implemented in the wireless communication system 1 described above with respect to FIGS. 1-6. For example, the various components included in the wireless communication system 1 can include the computing device 700.

Computing device 700 and/or 750 can also include USB flash drives. The USB flash drives may store operating systems and other applications. The USB flash drives can include input/output components, such as a wireless transmitter or USB connector that may be inserted into a USB port of another computing device.

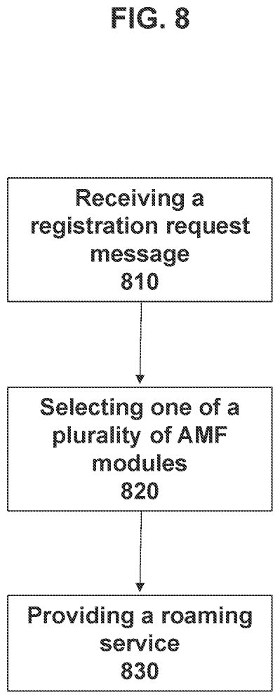

FIG. 8 is a flowchart illustrating an example registration procedure. In relation to this flowchart, the aforementioned description of providing a roaming service to a UE using a dedicated AMF module can be applied, and a redundant description is omitted. In the following flowchart, at least one step may be omitted or a new step may be added.

In step 810, a gNB can receive, from a user equipment (UE), a registration request message including a slice-id.

In step 820, the gNB can select one of a plurality of AMF modules each associated with one of a plurality of wireless communication service providers based on the slice-id, where the plurality of wireless communication service providers provide roaming services.

In step 830, one of the plurality of wireless communication service providers associated with the selected AMF module can provide the roaming service to the UE.

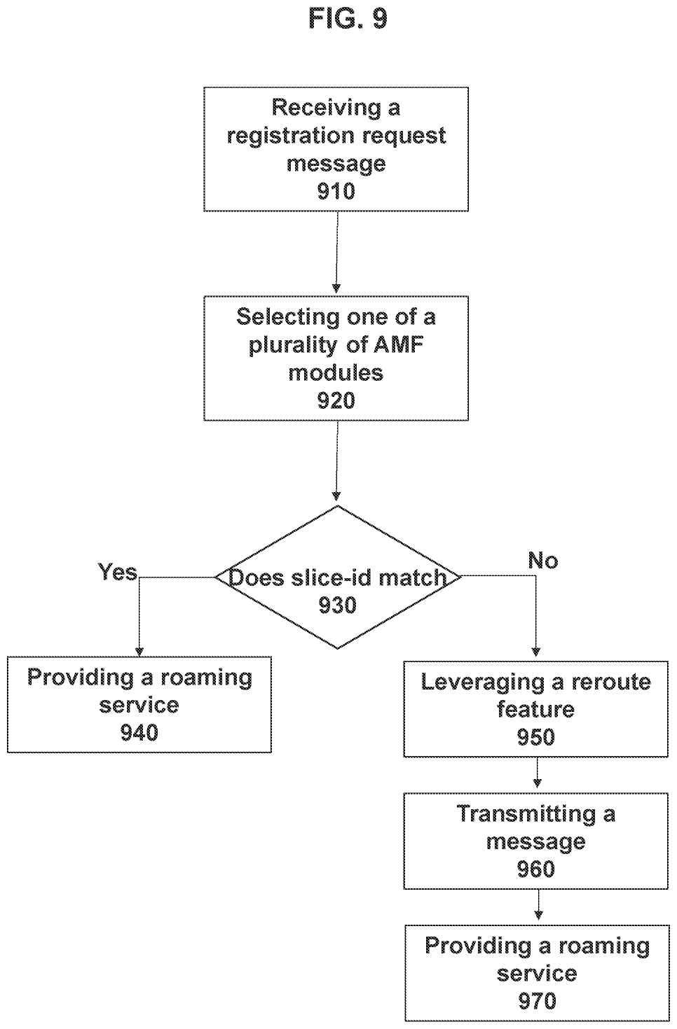

FIG. 9 is a flowchart illustrating a slice-id correction procedure. In relation to this flowchart, the aforementioned description of correcting a slice-id to correct an AMF module can be applied, and a redundant description is omitted. In the following flowchart, at least one step may be omitted or a new step may be added.

In step 910, a gNB can receive, from a user equipment, a registration request message including a slice-id.

In step 920, the gNB can select one of a plurality of AMF modules each associated with one of a plurality of wireless communication service providers based on the slice-id, where the plurality of wireless communication service providers provide roaming services.

In step 930, the selected AMF module can determine whether the slice-id included in the registration request message matches a -provisioned slice-id associated with the UE.

In step 940, if the selected AMF module determined that the slice-id included in the registration request message matches a provisioned slice-id associated with the UE, one of the plurality of wireless communication service providers associated with the selected AMF module can provide the roaming service to the UE.

In step 950, if the selected AMF module determined that the slice-id included in the registration request message does not match a stored slice-id associated with the UE, the selected AMF can leverage a NSSF and NAS reroute feature redirecting the UE request to the gNB to correct the slice-id and to reroute the request to the appropriate AMF.

In step 960, the AMF can transmit, via the gNB to a UE, a message indicating the corrected slice-id.

In step 970, one of the plurality of wireless communication service providers associated with the AMF associated with the corrected slice-id can provide the roaming service.

Although a few implementations have been described in detail above, other modifications may be made without departing from the scope of the inventive concepts described herein, and, accordingly, other implementations are within the scope of the following claims.

What is claimed is:

1. A method for correcting an access and mobility management function (AMF) module, the method comprising:
receiving, from a user equipment (UE), a registration request message including a slice identifier;
selecting, by a network node, an AMF module from a plurality of AMF modules each associated with one of a plurality of wireless communication service providers, the plurality of wireless communication service providers providing roaming services;
determining, by the selected AMF module, whether the slice identifier matches a provisioned slice identifier associated with the UE;
based on a determination that the slice identifier matches with the provisioned slice identifier, providing the roaming service by one of the plurality of wireless communication service providers associated with the selected AMF module; and
based on a determination that the slice identifier does not match with the provisioned slice identifier:
leveraging, by the selected AMF module, a reroute feature to the network node to correct the slice identifier,
transmitting, to an AMF module associated with the corrected slice identifier, a message indicating the corrected slice identifier, and
providing the roaming service by one of the plurality of wireless communication service providers associated with the AMF module that is associated with the corrected slice identifier.

2. The method of claim 1, wherein the reroute feature includes:
transmitting, by the selected AMF module, a reroute request message to the network node, and
rerouting, by the network node based on the reroute request message, the registration request message to an AMF module associated with the provisioned slice identifier.

3. The method of claim 1, wherein the slice identifier is assigned to the UE.

4. The method of claim 1, wherein the plurality of wireless communication service providers are each assigned with a corresponding slice identifier.

5. The method of claim 1, wherein selecting the AMF module from the plurality of AMF modules comprises:
based on the UE supporting a slice differentiator included in the registration request message, selecting, by the network node, an AMF module corresponding to the slice identifier, and
based on the UE not supporting the slice differentiator, selecting, by the network node, a predefined AMF module from the plurality of AMF modules.

6. A wireless communication system comprising:
a network node that is configured to receive, from a user equipment (UE), a registration request message including a slice identifier; and
a plurality of access and mobility management functions (AMF) modules each associated with one of a plurality of wireless communication service providers, the plurality of wireless communication service providers providing roaming services,
wherein the network node is configured to select an AMF module from the plurality of AMF modules,
wherein the selected AMF module is configured to determine whether the slice identifier matches a stored slice identifier associated with the UE,
wherein, based on a determination that the slice identifier matches with the stored slice identifier, one of the plurality of wireless communication service providers associated with the selected AMF module provides the roaming service, and
wherein, based on a determination that the slice identifier does not match with the stored slice identifier:
the selected AMF module is configured to leverage a reroute feature to the network node to correct the slice identifier,
the network node is configured to transmit, to an AMF module associated with the corrected slice identifier, a message indicating the corrected slice identifier, and
one of the plurality of wireless communication service providers associated with the AMF module that is associated with the corrected slice identifier is configured to provide the roaming service.

7. The wireless communication system of claim 6, wherein the reroute feature includes:
transmitting, by the selected AMF module, a reroute request message to the network node, and
rerouting, by the network node based on the reroute request message, the registration request message to an AMF module associated with the stored slice identifier.

8. The wireless communication system of claim 6, wherein the slice identifier is assigned to the user equipment.

9. The wireless communication system of claim 6, wherein the plurality of wireless communication service providers are each assigned with a corresponding slice identifier.

10. The wireless communication system of claim 6, wherein selecting the AMF module from the plurality of AMF modules comprises:
based on the UE supporting a slice differentiator included in the registration request message, selecting, by the network node, an AMF module corresponding to the slice identifier, and
based on the UE not supporting the slice differentiator, selecting, by the network node, a predefined AMF module from the plurality of AMF modules.

11. A non-transitory recording medium storing a program, wherein execution of the program causes one or more computers of a wireless communication system to perform operations comprising:
receiving, from a user equipment (UE), a registration request message including a slice identifier;
selecting, by a network node, an AMF module from a plurality of AMF modules each associated with one of a plurality of wireless communication service providers, the plurality of wireless communication service providers providing roaming services;
determining, by the selected AMF module, whether the slice identifier matches a stored slice identifier associated with the UE;
based on a determination that the slice identifier matches with the provisioned slice identifier, providing the roaming service by one of the plurality of wireless communication service providers associated with the selected AMF module; and
based on a determination that the slice identifier does not match with the provisioned slice identifier:
leveraging, by the selected AMF module, a reroute feature to the network node to correct the slice identifier,
transmitting, to an AMF module associated with the corrected slice identifier, a message indicating the corrected slice identifier, and
providing the roaming service by one of the plurality of wireless communication service providers associated with the AMF module that is associated with the corrected slice identifier.

12. The non-transitory recording medium of claim 11, wherein the reroute feature includes:
transmitting, by the selected AMF module, a reroute request message to the network node, and
rerouting, by the network node based on the reroute request message, the registration request message to an AMF module associated with the provisioned slice identifier.

13. The non-transitory recording medium of claim 11, wherein the slice identifier is assigned to the user equipment.

14. The non-transitory recording medium of claim 11, wherein the plurality of wireless communication service providers are each assigned with a corresponding slice identifier.

15. The non-transitory recording medium of claim 11, wherein selecting the AMF module from the plurality of AMF modules comprises:
based on the UE supporting a slice differentiator included in the registration request message, selecting, by the network node, an AMF module corresponding to the slice identifier, and
based on the UE not supporting the slice differentiator, selecting, by the network node, a predefined AMF module from the plurality of AMF modules.
